(19) United States
(12) Patent Application Publication
(10) Pub. No.: US 2006/0195628 A1
(43) Pub. Date: Aug. 31, 2006

(54) System and method for DMA transfer between FIFOs

(75) Inventor: Yasuyuki Hori, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: FUJITSU LIMITED, Kawasaki (JP)

(21) Appl. No.: 11/152,143

(22) Filed: Jun. 15, 2005

(30) Foreign Application Priority Data
Feb. 28, 2005 (JP) 2005-054631

(51) Int. Cl. G06F 13/28

(52) U.S. Cl. 710/22

(57) ABSTRACT

A system for DMA transfer includes a CPU core having a DMA function, a first macro including a FIFO having a first bit width, and a second macro including a FIFO having a second bit width narrower than the first bit width, wherein an address signal fixing circuit is provided, and is configured to fix a portion of an address for accessing from the CPU core the FIFO of the second macro.

### CROSS-REFERENCE TO RELATED APPLICATIONS

The present application is based upon and claims the benefit of priority from the prior Japanese Patent Application No. 2005-054631 filed on Feb. 28, 2005, with the Japanese Patent Office, the entire contents of which are incorporated herein by reference.

### BACKGROUND OF THE INVENTION

1. Field of the Invention

The present invention generally relates to DMA transfer systems and DMA transfer methods, and particularly relates to a DMA transfer system and DMA transfer method which perform DMA data transfer between FIFOs.

2. Description of the Related Art

DMA (direct memory access) transfer systems provide for high-speed data transfer to be achieved without using an intervening CPU. When DMA transfer is to be conducted between two FIFOs which are located in two respective chip select areas having different bus widths, there may be a need to use an intervening RAM or the like as a buffer between the source of the transfer and the destination of the transfer.

FIG. 1 is a drawing showing an example of the configuration of a related-art DMA transfer system. A DMA transfer system 10 of FIG. 1 includes a CPU core 11, a first macro 12, a RAM 13, and a second macro 14. The CPU core 11 includes a CPU 15, a DMA controller 16, a bus converter 17, and an external bus interface 18. The CPU 15, the DMA controller 16, and the external bus interface 18 are coupled to each other via busses and the bus converter 17.

The external bus interface 18 is coupled to the first macro 12 and the RAM 13 through 32-bit buses, and is coupled to the second macro 14 through a 16-bit bus. The first macro 12 and the second macro 14 are allocated to respective, separate chip select areas in memory space. Namely, a chip select signal transmitted from the external bus interface 18 to the first macro 12 is separate from the chip select signal transmitted to the second macro 14.

Each of the first macro 12 and the second macro 14 has a FIFO (First-in First-out) therein. With a fixed address in each macro serving as an access point to the FIFO, data read/write operations are performed successively with respect to this fixed address, thereby achieving access to the FIFO.

The CPU 15 specifies a DMA transfer source address, a transfer destination address, a transfer data size, an increment/decrement of the transfer source address, an increment/decrement of the transfer destination address, etc., thereby determining the settings of DMA transfer with respect to the DMA controller 16. In response, the DMA controller 16 performs the specified DMA transfer.

An example of DMA transfer will be examined below in which 32-bit data is read from the FIFO of the first macro 12, and is written to the FIFO of the second macro 14 as two 16-bit data pieces. In this case, the DMA transfer operation needs to write to the FIFO of the second macro 14 the first 16-bit half of the 32-bit data read from the FIFO of the first macro 12, then followed by writing the second 16-bit half to the FIFO of the second macro 14. In this operation, the address from which the data is read is a fixed address in the first macro 12, and the address to which the data is written is a fixed address in the second macro 14.

Since signals from the DMA controller 16 pass through the external bus interface 18, an address signal indicative of an access address may automatically be incremented by the external bus interface 18. In such a case, when the first 16-bit half of the 32-bit data read from the first macro 12 is written to the fixed address of the FIFO of the second macro 14, the second 16-bit half ends up being written to a next address rather than written to the fixed address of the FIFO of the second macro 14. Namely, because of the address increment operation by the external bus interface 18, an operation unexpected for the DMA controller 16 is performed.

Normally, when one 32-bit data piece is to be written as two 16-bit data pieces, it is expected as a proper operation to write the two 16-bit data pieces to two consecutive addresses. In order to perform such a proper operation, the external bus interface 18 increments the address to which the second 16-bit half is written. If the transfer destination is a FIFO, however, the transfer destination needs to be a single fixed address, and the incrementing of the destination address means a failure to perform a correct operation.

In order to obviate this, conventionally, the 32-bit data read from the FIFO of the first macro 12 is first stored in the RAM 13 as a 32-bit data piece. The RAM 13 generally allows access to be made by the units of 32-bit data, and also allows access to be made by the units of 16-bit data. In consideration of this, the first 16-bit half of the 32-bit data stored in the RAM 13 is first read for transmission to the fixed address of the FIFO of the second macro 14, and, then, the second 16-bit half is read for transmission to the fixed address of the FIFO of the second macro 14. In this case, the reading of data from the RAM 13 is done by the units of 16 bits, and the writing of data to the second macro 14 is done by the units of 16 bits also. Accordingly, the external bus interface 18 does not increment the address.

In this manner, the related-art DMA transfer system needs to use a RAM or the like as a temporal data storage buffer when DMA transfer is performed between two FIFOs allocated to two separate chip select areas having different bus widths. In such a case, direct data transfer cannot be performed between the FIFOs, resulting in a drop in data transfer efficiency.

[Patent Document 1] Japanese Patent Application Publication No. 2000-322375

Accordingly, there is a need for a DMA transfer system which can perform DMA transfer without using a buffer such as a RAM between two FIFOs allocated to two separate chip select areas having respective different bus widths.

### SUMMARY OF THE INVENTION

It is a general object of the present invention to provide a DMA transfer system and method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a DMA transfer system and method particularly pointed out in the specification in such full, clear, concise, and exact terms as to enable a person having ordinary skill in the art to practice the invention.

To achieve these and other advantages in accordance with the purpose of the invention, the invention provides a system for DMA transfer, which includes a CPU core having a DMA function, a first macro including a FIFO having a first bit width, and a second macro including a FIFO having a second bit width narrower than the first bit width, wherein an address signal fixing circuit is provided, and is configured to fix a portion of an address for accessing from the CPU core the FIFO of the second macro.

A method of performing DMA transfer includes the steps of reading data having a first bit width from a FIFO having the first bit width provided in a first macro, writing the read data to a FIFO having a second bit width narrower than the first bit width provided in a second macro through multiple writings of data having the second bit width, and fixing a portion of an address for accessing the FIFO of said second macro during a period in which the multiple writings are performed.

According to at least one embodiment of the present invention, the address signal fixing circuit fixes a portion of an address signal to predetermined bit values, thereby making it possible to access a correct FIFO address (i.e., the access point to the FIFO) even if the address signal is automatically incremented. Accordingly, proper DMA operation can be performed without using a buffer such as a RAM between the two FIFOs allocated to two respective chip select areas having different bus widths.

### BRIEF DESCRIPTION OF THE DRAWINGS

Other objects and further features of the present invention will be apparent from the following detailed description when read in conjunction with the accompanying drawings, in which:

FIG. 1 is a drawing showing an example of the configuration of a related-art DMA transfer system;

FIG. 2 is a drawing showing a first embodiment of the configuration of a DMA transfer system according to the present invention;

FIG. 3 is a flowchart showing a DMA transfer process performed in the configuration shown in FIG. 2;

FIG. 4 is a signal timing chart showing the timing of signals with respect to the DMA transfer process performed in the configuration shown in FIG. 2;

FIG. 5 is a drawing showing a configuration in which a circuit having an address-signal masking function is provided outside a second macro;

FIG. 6 is a drawing showing a second embodiment of the configuration of the DMA transfer system according to the present invention; and

FIG. 7 is a signal timing chart showing the timing of signals with respect to a DMA transfer process performed by the configuration shown in FIG. 6.

### DESCRIPTION OF THE PREFERRED EMBODIMENTS

In the following, embodiments of the present invention will be described with reference to the accompanying drawings.

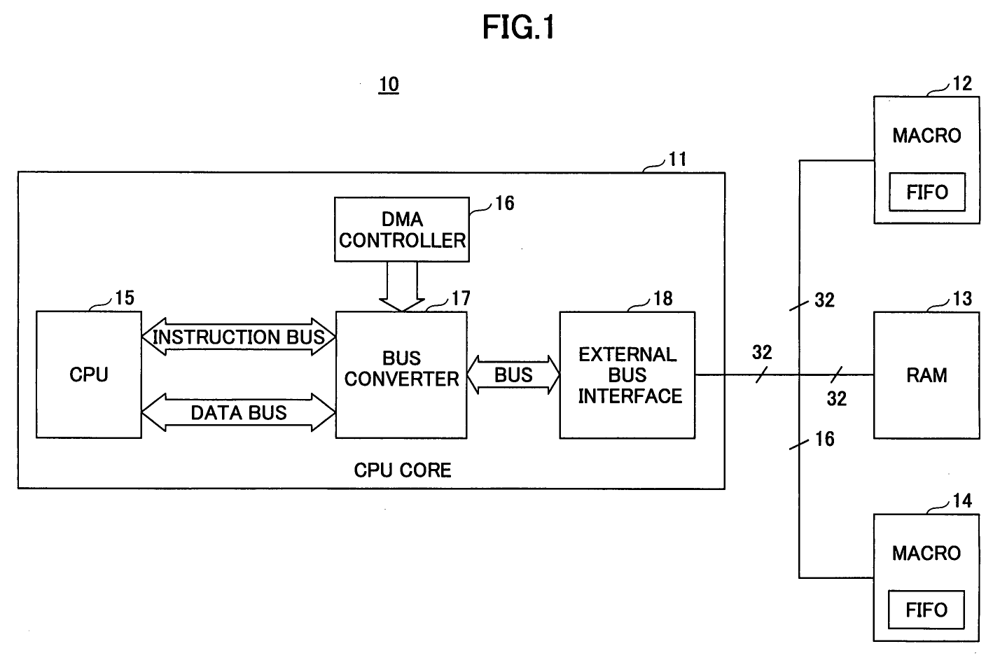

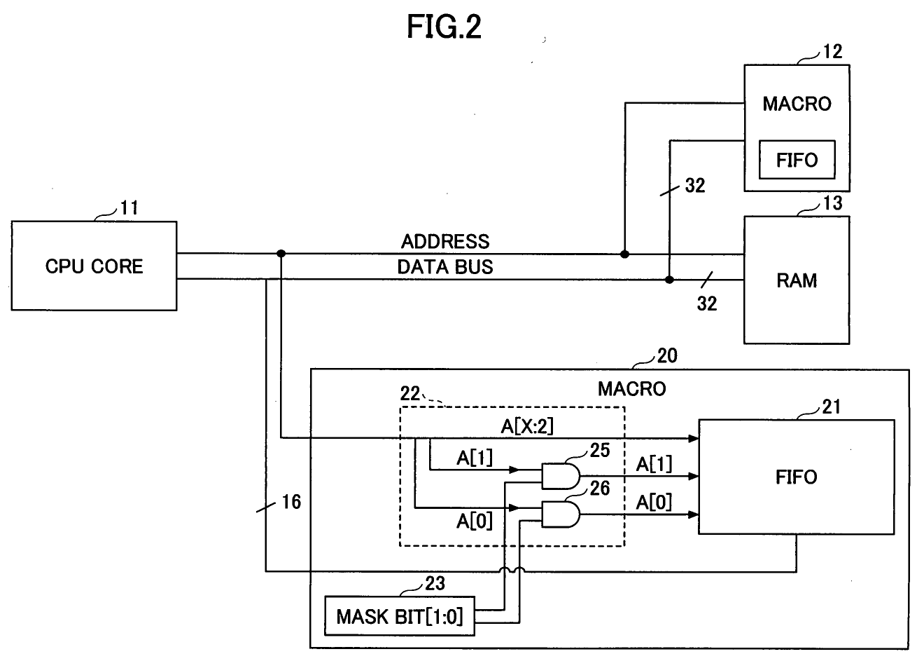

FIG. 2 is a drawing showing a first embodiment of the configuration of a DMA transfer system according to the present invention. In FIG. 2, the same elements as those of FIG. 1 are referred to by the same numerals.

A DMA transfer system of FIG. 2 includes the CPU core 11, the first macro 12, the RAM 13, and a second macro 20. The CPU core 11 includes the CPU 15, the DMA controller 16, the bus converter 17, and the external bus interface 18 as shown in FIG. 1.

The CPU core 11 is coupled to the first macro 12 and the RAM 13 through 32-bit data buses, and is coupled to the second macro 20 through a 16-bit data bus. The CPU core 11 is further coupled to the first macro 12, the RAM 13, and the second macro 20 through address busses, and supplies address signals via the address busses.

The first macro 12 and the second macro 20 are allocated to respective, separate chip select areas in memory space. Namely, a chip select signal transmitted from the external bus interface of the CPU core 11 to the first macro 12 is separate from the chip select signal transmitted to the second macro 20. Here, these chip select signals are not expressly illustrated, but signal lines for the chip select signals may properly be included in the address busses.

Each of the first macro 12 and the second macro 14 has a FIFO (First-in First-out) therein. With a fixed address in each macro serving as an access point to the FIFO, data read/write operations are performed successively with respect to this fixed address, thereby achieving access to the FIFO.

The CPU 15 (FIG. 1) in the CPU core 11 specifies a DMA transfer source address, a transfer destination address, a transfer data size, an increment/decrement of the transfer source address, an increment/decrement of the transfer destination address, etc., thereby determining the settings of DMA transfer with respect to the DMA controller 16 (FIG. 1). In response, the DMA controller 16 performs the specified DMA transfer.

An example of DMA transfer will be examined below in which 32-bit data is read from the FIFO of the first macro 12, and is written to the FIFO of the second macro 20 as two 16-bit data pieces. In this case, the DMA transfer operation needs to write to the FIFO of the second macro 20 the first 16-bit half of the 32-bit data read from the FIFO of the first macro 12, then followed by writing the second 16-bit half to the FIFO of the second macro 20. In this operation, the address from which the data is read is a fixed address in the first macro 12, and the address to which the data is written is a fixed address in the second macro 20.

As was described in connection with FIG. 1, however, signals from the DMA controller 16 pass through the external bus interface 18, so that an address signal indicative of an access address may automatically be incremented by the external bus interface 18.

In the second macro 20 shown in FIG. 2, an address-signal masking circuit is provided so as to access a correct FIFO address (i.e., the access point to the FIFO) even if the address signal is automatically incremented in the manner as described above. As illustrated in FIG. 2, the second macro 20 includes a FIFO 21, an address-signal masking circuit 22, and a mask setting register 23.

The FIFO 21 and the mask setting register 23 are illustrated as separate units for the sake of convenience of explanation. These may be separate register units, or may be, in actual configuration, a portion of the memory circuit provided in the second macro 20. In the same manner as the CPU core 11 specifies an address and writes data to the FIFO 21, the CPU core 11 may specify an address of the mask setting register 23 and write mask bits to the mask setting register 23.

The address-signal masking circuit 22 includes AND gates 25 and 26, for example. In response to the mask-bit settings of the mask setting register 23, the address-signal masking circuit 22 masks the two lower-order bits A[0] and A[1] of the address signal on the address bus. Namely, when the two-bit mask bits are both set to “0”, the two lower-order bits A[0] and A[1] of the address signal on the address bus are blocked by the AND gates 25 and 26. With this provision, the two lower-order bits A[0] and A[1] of the address signal supplied to the FIFO 21 become “0”.

The configuration of the address-signal masking circuit 22 described above is designed for a case in which the two lower-bits of the address of the FIFO 21 (i.e., the access point to the FIFO) are “00”. If the two lower-bits of the address of the FIFO 21 (i.e., the access point to the FIFO) are “01”, a NAND gate may be provided in place of the AND gate 26. In this manner, the address-signal masking circuit 22 is configured such that the two lower-order bits A[0] and A[1] of the address signal become equal to the two lower bits of the FIFO address.

With such configuration, it is possible to write the first 16-bit half of the 32-bit data read from the first macro 12 to the fixed address of the FIFO of the second macro 20 and to write the second 16-bit half also to the fixed address of the FIFO of the second macro 20. Namely, the address to which the second 16-bit half is written is incremented when the address is supplied from the CPU core 11. The address-signal masking function of the present invention, however, masks the lower bits of the address signal so as to fix them to predetermined bit values, thereby making it possible to select the fixed address of the FIFO as the address to which the data is written.

According to the first embodiment of the present invention as described above, the address-signal masking circuit 22 masks the lower-order bits of the address signal (i.e., fixes these bits to predetermined bit values), thereby making it possible to access a correct FIFO address (the access point to the FIFO) even if the address signal is automatically incremented. Accordingly, the present invention can perform proper DMA operation without using a buffer such as a RAM between the two FIFOs allocated to two respective chip select areas having different bus widths.

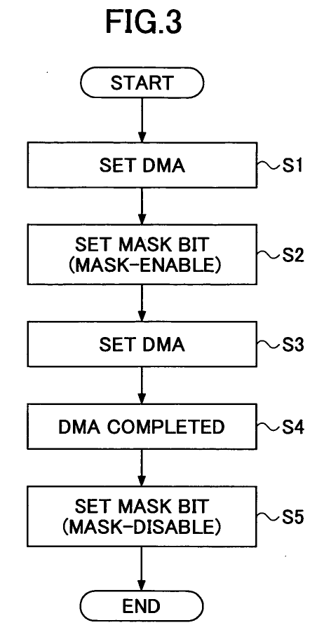

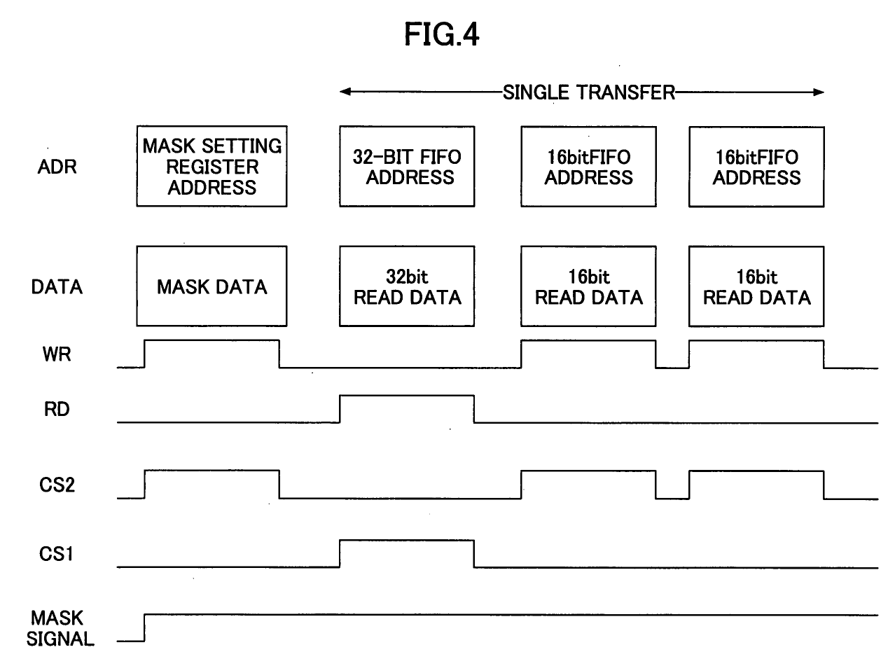

FIG. 3 is a flowchart showing a DMA transfer process performed in the configuration shown in FIG. 2. FIG. 4 is a signal timing chart showing the timing of signals with respect to the DMA transfer process performed in the configuration shown in FIG. 2. In the following, the operation of the DMA transfer system of FIG. 2 will be described with reference to FIG. 3 and FIG. 4.

In step S1 of FIG. 3, individual conditions of DMA transfer are specified. Namely, the CPU 15 (FIG. 1) of the CPU core 11 specifies a DMA transfer source address, a transfer destination address, a transfer data size, an increment/decrement of the transfer source address, an increment/decrement of the transfer destination address, etc., thereby determining the settings of DMA transfer with respect to the DMA controller 16 (FIG. 1). In step S2, a process of setting the mask bits (mask-enable) is performed. Namely, as shown in FIG. 4, the CPU core 11 transmits a mask-setting register address as an address signal ADR to the address bus, and also transmits mask data as a data signal DATA to the data bus. Further, a write signal WR transmitted from the CPU core 11 is asserted (at HIGH), and, also, a chip select signal CS2 transmitted from the CPU core 11 to the second macro 20 is asserted (at HIGH). This results in the mask bits being set in the mask setting register 23 of the second macro 20. The HIGH state of the mask signal shown in FIG. 4 exemplifies the fact that the address-signal masking circuit 22 is placed in the masking state.

In step S3, a DMA transfer operation is activated according to the DMA settings. Specifically, the CPU 15 (FIG. 1) of the CPU core 11, for example, may remove a channel mask from the DMA channel that is prepared in step S1, thereby letting the DMA controller 16 (FIG. 1) activate DMA transfer.

In response to the activation of DMA transfer, the CPU core 11 transmits the FIFO address of the first macro 12 (32 bit) as an address signal ADR to the address bus, and, also, asserts a read signal RD (at HIGH). Further, a chip select signal CS1 with respect to the first macro 12 is asserted (at HIGH). With this provision, 32-bit data is read from the FIFO of the first macro 12 to the data bus.

Thereafter, the CPU core 11 transmits the FIFO address of the second macro 20 (16 bits) as an address signal ADR to the address bus, and asserts the write signal WR (at HIGH). Further, the chip select signal CS2 with respect to the second macro 20 is asserted (at HIGH). Also, the first half of the 32-bit data read from the first macro 12 is supplied to the data bus as 16-bit data. With this provision, the 16-bit data constituting the first half of the 32-bit data read from the first macro 12 is written to the FIFO of the second macro 20.

Moreover, the CPU core 11 again transmits the FIFO address of the second macro 20 (16 bits) as an address signal ADR to the address bus, and asserts the write signal WR (at HIGH). Further, the chip select signal CS2 with respect to the second macro 20 is asserted (at HIGH). Also, the second half of the 32-bit data read from the first macro 12 is supplied to the data bus as 16-bit data. With this provision, the 16-bit data constituting the second half of the 32-bit data read from the first macro 12 is written to the FIFO of the second macro 20.

In step S4, the DMA transfer comes to an end. Inside the CPU core 11, the CPU 15 detects the completion of the DMA transfer by polling or interruption. The CPU 15 then performs such processes as checking a completion status stored in an internal register of the DMA controller 16.

In step S5, a process of setting the mask bits (mask-disable) is performed. Namely, the CPU core 11 transmits the mask-setting register address as an address signal ADR to the address bus, and also transmits mask data as a data signal DATA to the data bus. Further, the write signal WR transmitted from the CPU core 11 is asserted (at HIGH), and, also, the chip select signal CS2 transmitted from the CPU core 11 to the second macro 20 is asserted (at HIGH). This results in the mask bits being cancelled in the mask setting register 23 of the second macro 20.

Unless the mask bits are cancelled in this manner, subsequent access to the second macro 20 cannot perform a proper access operation, with the lower-order bits of the address signal being masked. Accordingly, there is a need to cancel the mask bits after the completion of the DMA transfer as shown in FIG. 3.

With respect to the configuration shown in FIG. 2, the address-signal masking circuit 22 and the mask setting register 23 were described as being a portion of the second macro 20. The present invention is not limited to this configuration. Provision may be made such that a circuit having the address-signal masking function is provided outside the second macro, thereby masking the address signal on the address bus outside the second macro.

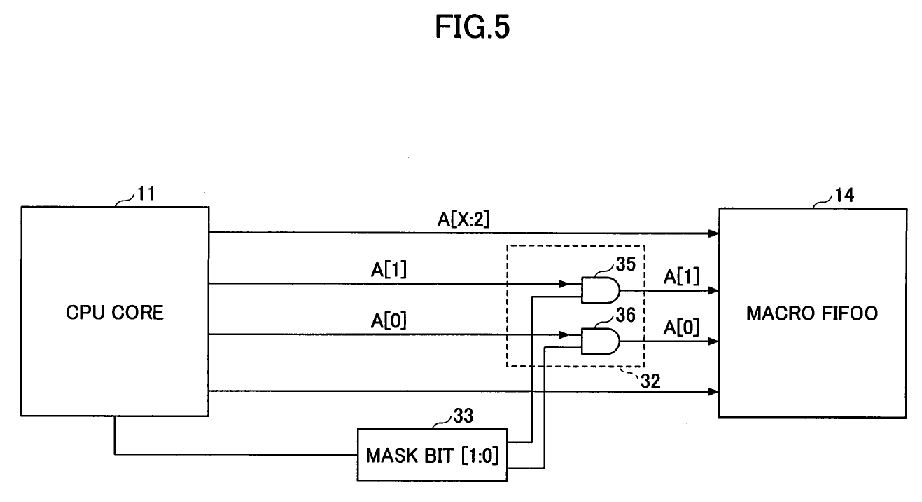

FIG. 5 is a drawing showing a configuration in which a circuit having the address-signal masking function is provided outside the second macro. In FIG. 5, the first macro 12 and the RAM 13 are omitted from the illustration.

In the configuration shown in FIG. 5, an address-signal masking circuit 32 is provided between the CPU core 11 and the second macro. In this case, the second macro serving as a transfer destination may be the second macro 14 shown in the related-art configuration of FIG. 1.

The address-signal masking circuit 32 includes AND gates 35 and 36, for example. In response to mask bit settings in a mask setting register 33, the address-signal masking circuit 32 masks the two lower-order bits A[0] and A[1] of the address signal on the address bus. Namely, the address-signal masking circuit 32 sets the two lower-order bits A[0] and A[1] of the address signal such as to make them equal to the two lower-order bits of the FIFO address of the second macro 14.

Such a configuration can produce the same advantages as the configuration shown in FIG. 2. Namely, it is possible to perform proper DMA operation without using a buffer such as a RAM between the two FIFOs allocated to two respective chip select areas having different bus widths.

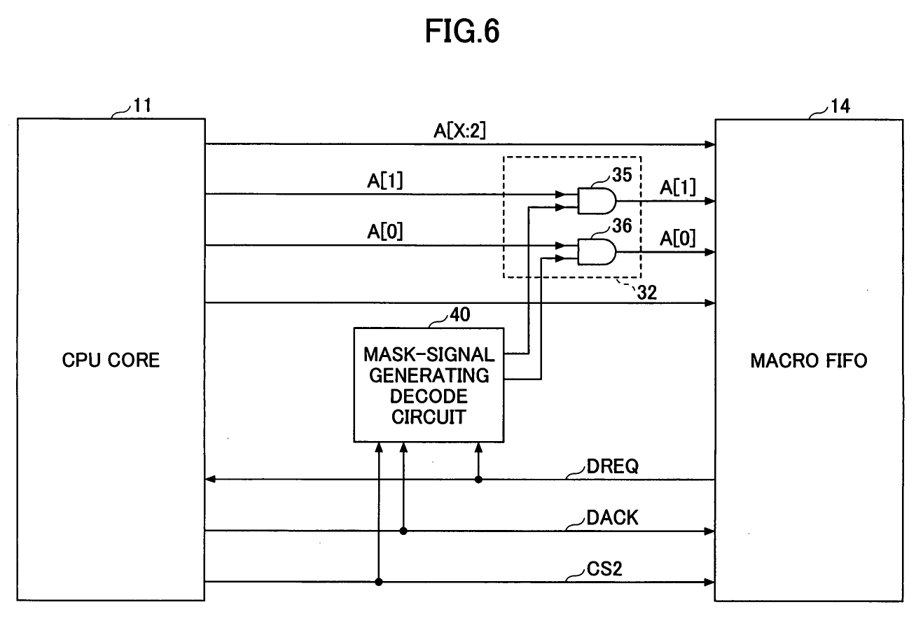

FIG. 6 is a drawing showing a second embodiment of the configuration of the DMA transfer system according to the present invention. In FIG. 6, the same elements as those of FIG. 5 are referred to by the same numerals.

In the configuration shown in FIG. 6, a mask-signal generating decode circuit 40 is used in place of the mask setting register 33 shown the configuration of FIG. 5. The mask-signal generating decode circuit 40 receives a DMA transfer request signal DREQ supplied from the second macro 14 to the CPU core 11, a DMA transfer signal (DMA acknowledge signal) DACK supplied from the CPU core 11 to the second macro 14, and the chip select signal CS2 supplied from the CPU core 11 to the second macro 14. The mask-signal generating decode circuit 40 decodes these signals to generate a signal that instructs the address-signal masking circuit 32 to execute a masking operation.

In general, an activation of DMA transfer includes an activation based on an external request mode and an activation based on an internal auto-request. The internal auto-request is used when data is transferred between macros that cannot transmit a DMA transfer request on its own, for example. In such a case, a request for DMA activation is generated inside the CPU core 11. In the external request mode, on the other hand, an external macro such as the second macro 14 asserts the DMA transfer request to the CPU core 11, thereby activating a DMA transfer. The configuration shown in FIG. 6 is applicable to a case in which DMA transfer is activated by use of an external request mode.

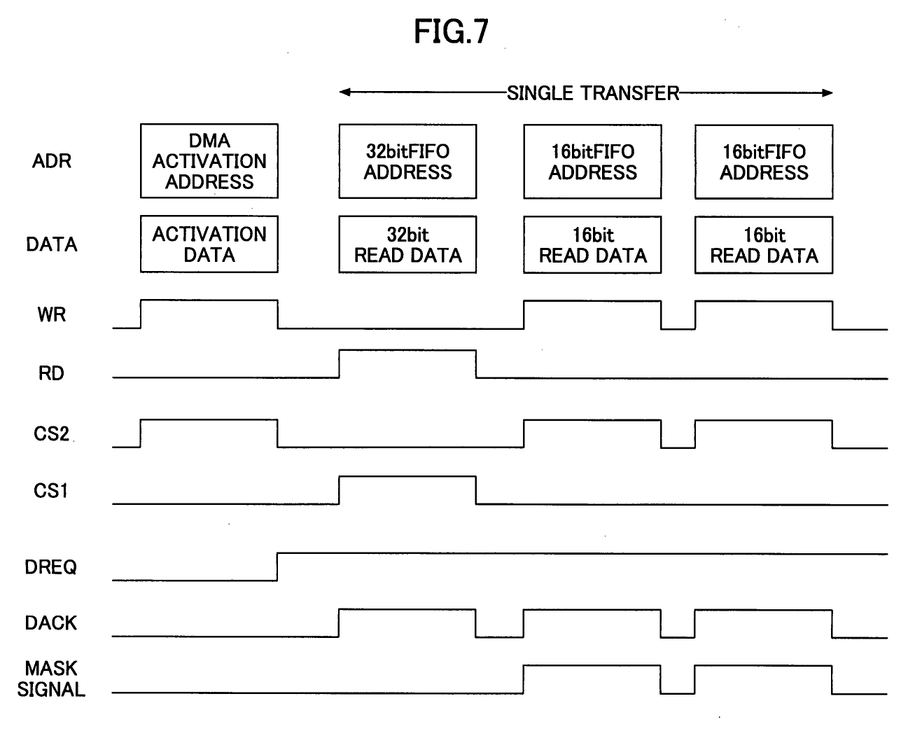

FIG. 7 is a signal timing chart showing the timing of signals with respect to a DMA transfer process performed by the configuration shown in FIG. 6. In the following, the operation of the DMA transfer system shown in FIG. 6 will be described with reference to FIG. 7.

The CPU core 11 transmits a DMA activation address (a predetermined address in the second macro 14 in this example) as an address signal ADR to the address bus, and, also, transmits activation data as a data signal DATA to the data bus. Further, the write signal WR transmitted from the CPU core 11 is asserted (at HIGH), and, also, the chip select signal CS2 transmitted from the CPU core 11 to the second macro 14 is asserted (at HIGH). In response, the second macro 14 serving as a source of DMA activation asserts the DMA transfer request signal DREQ (at HIGH).

As DMA transfer is activated, the CPU core 11 transmits the FIFO address of the first macro 12 (32 bit) as an address signal ADR to the address bus, and, also, asserts the read signal RD (at HIGH). Further, the chip select signal CS1 with respect to the first macro 12 is asserted (at HIGH). Moreover, the CPU core 11 asserts the DMA transfer signal DACK (at HIGH) indicative of the execution of a DMA transfer operation. With this provision, 32-bit data is read from the FIFO of the first macro 12 to the data bus.

Thereafter, the CPU core 11 transmits the FIFO address of the second macro 14 (16 bits) as an address signal ADR to the address bus, and asserts the write signal WR (at HIGH). Further, the chip select signal CS2 with respect to the second macro 14 is asserted (at HIGH). Moreover, the CPU core 11 asserts the DMA transfer signal DACK (at HIGH) indicative of the execution of a DMA transfer operation. Also, the first half of the 32-bit data read from the first macro 12 is supplied to the data bus as 16-bit data. With this provision, the 16-bit data constituting the first half of the 32-bit data read from the first macro 12 is written to the FIFO of the second macro 14.

The address-signal masking circuit 32 performs an AND operation between the DMA transfer request signal DREQ, the DMA transfer signal DACK, and the chip select signal CS2, thereby generating a masking signal in the asserted state (HIGH). The HIGH state of the masking signal corresponds to the masking state of the address-signal masking circuit 32. Specifically, this mask signal is inverted for provision to the AND gates 35 and 36 of the address-signal masking circuit 32.

Thereafter, the CPU core 11 again transmits the FIFO address of the second macro 14 (16 bits) as an address signal ADR to the address bus, and asserts the write signal WR (at HIGH). Further, the chip select signal CS2 with respect to the second macro 14 is asserted (at HIGH). Moreover, the CPU core 11 asserts the DMA transfer signal DACK (at HIGH) indicative of the execution of a DMA transfer operation. Also, the second half of the 32-bit data read from the first macro 12 is supplied to the data bus as 16-bit data. With this provision, the 16-bit data constituting the second half of the 32-bit data read from the first macro 12 is written to the FIFO of the second macro 14. When this is done, the masking signal is in the HIGH state, so that the address-signal masking circuit 32 is in the masking state.

According to the second embodiment of the present invention as described above, the address-signal masking circuit 32 masks the lower-order bits of the address signal (i.e., fixes these bits to predetermined bit values), thereby making it possible to access a correct FIFO address (the access point to the FIFO) even if the address signal is automatically incremented. Accordingly, the present invention can perform proper DMA operation without using a buffer such as a RAM between the two FIFOs allocated to two respective chip select areas having different bus widths.

With respect to the configuration shown in FIG. 6, the address-signal masking circuit 32 and the mask-signal generating decode circuit 40 were described as being provided outside the second macro 14. The present invention is not limited to this configuration. Provision may be made such that circuits having the same functions as these circuits are provided inside the second macro, thereby masking the address signal on the address bus inside the second macro.

Further, the present invention is not limited to these embodiments, but various variations and modifications may be made without departing from the scope of the present invention.

What is claimed is:

1. A system for DMA transfer, comprising:
a CPU core having a DMA function;
a first macro including a FIFO having a first bit width;
a second macro including a FIFO having a second bit width narrower than the first bit width; and
an address signal fixing circuit configured to fix a portion of an address for accessing from said CPU core the FIFO of said second macro.

2. The system as claimed in claim 1, wherein said address signal fixing circuit fixes the portion of the address during a DMA transfer by which said CPU core reads data having the first bit width from the FIFO of said first macro, and writes the data having the first bit width to the FIFO of said second macro through multiple writings of data having the second bit width.

3. The system as claimed in claim 2, wherein said address signal fixing circuit includes a register accessible from said CPU core, and fixes the portion of the address in response to a value stored by said CPU core in said register where said value indicates an ongoing execution of the DMA transfer.

4. The system as claimed in claim 2, wherein said address signal fixing circuit fixes the portion of the address in response to assertion of all of a DMA request signal supplied from said second macro to said CPU core, a DMA acknowledge signal supplied from said CPU core to said second macro, and a chip select signal supplied from said CPU core to said second macro.

5. The system as claimed in claim 1, wherein a chip select signal supplied from said CPU core to said first macro is different from a chip select signal supplied from said CPU core to said second macro.

6. The system as claimed in claim 1, further comprising:
a data bus having the first bit width connecting between said CPU core and said first macro; and
a data bus having the second bit width connecting between said CPU core and said second macro.

7. The system as claimed in claim 6, wherein said CPU core includes:
a CPU;
a DMA controller; and
an external bus interface configured to connect said CPU and said DMA controller to the data buses.

8. The system as claimed in claim 1, wherein said address signal fixing circuit fixes one or more lower-order bits of the address as the portion of the address.

9. The system as claimed in claim 8, wherein said address signal fixing circuit fixes the one or more lower-order bits, as a result of which the address is fixed to an address of the FIFO of said second macro.

10. A method of performing DMA transfer, comprising:
reading data having a first bit width from a FIFO having the first bit width provided in a first macro;
writing the read data to a FIFO having a second bit width narrower than the first bit width provided in a second macro through multiple writings of data having the second bit width; and
fixing a portion of an address for accessing the FIFO of said second macro during a period in which the multiple writings are performed.
